(19) United States
(12) Patent Application Publication
(10) Pub. No.: US 2025/0302138 A1
(43) Pub. Date: Oct. 2, 2025

(54) MESOSTRUCTURES AND PROCESS FOR HELMET FIT

(71) Applicant: VIRGINIA TECH INTELLECTUAL PROPERTIES, INC., Blacksburg, VA (US)

(72) Inventor: William J. Makowski, Roanoke, VA (US)

(21) Appl. No.: 18/866,598

(22) PCT Filed: May 25, 2023
(86) PCT No.: PCT/US2023/067470

§ 371 Date: Nov. 18, 2024

Related U.S. Application Data
(60) Provisional application No. 63/365,296, filed on May 25, 2022.

(51) Int. Cl. A42B 3/10; A42C 2/00; G05B 19/4099

(52) U.S. Cl. CPC A42B 3/10; A42C 2/007; G05B 19/4099; G05B 2219/35134; G05B 2219/49023

(57) ABSTRACT

A custom-formed mesostructure for a helmet and process for designing the mesostructure are described. In one example, a process for designing a helmet for an individual can include generating a model of anthropometric aspects of a head of the individual using a scanning technique. The process can further include editing the model to generate a refined model of the anthropometric aspects of the head. The process can further include designing a mesostructure based on the refined model. The process can also include designing the mesostructure as a latticed structure having a thickness gradient that is relatively thinner along an inner periphery of the mesostructure and thicker along an outer periphery of the mesostructure, to reduce peak linear acceleration during an impact. The process can also include forming the mesostructure using an additive manufacturing technique. The mesostructure can be used independently as a helmet or combined with an outer shell.

### CROSS-REFERENCE TO RELATED APPLICATION

This application claims the benefit of and priority to U.S. Provisional Patent Application No. 63/365,296, titled “Mesostructures and Process for Helmet Fit,” filed May 25, 2022, the entire contents of which is hereby incorporated by reference herein.

### BACKGROUND

Individuals with improperly fitting helmets experience head injury more frequently than those with properly fitted helmets. It has been found that younger individuals with improperly fitting helmets, in particular, experience head injury more frequently. Researchers have discovered that more of the head-injured individuals had helmets that were too large for their heads, as compared with control subjects. These differences tended to exist more in younger individuals than in the older ones, suggesting that helmets fit better in older individuals. Sadly, the use of improperly fitting helmets for children and adults, and its relationship to greater risk of injury, has been continually identified over the last twenty years.

### SUMMARY

The present disclosure relates to a personalized helmet and a process for designing the same. More specifically, the present disclosure relates to a custom-formed mesostructure that can be designed to conform to anthropometric aspects of a particular individual's head. The mesostructure can be used independently as a helmet or combined with an outer shell to provide additional protection during an impact. The mesostructure can be designed to include a thickness gradient extending from an inner periphery to an outer periphery of the mesostructure, to reduce peak linear acceleration during an impact. The mesostructure can also be designed to account for the growth of a particular individual's head.

According to an example, a process for designing a helmet for an individual can include generating a model of anthropometric aspects of a head of the individual using a scanning technique. The process can further include editing the model to generate a refined model of the anthropometric aspects of the head. The process can further include designing a mesostructure based on the refined model. In some cases, the process can include designing the mesostructure such that an inner periphery of the mesostructure conforms to an outer periphery of the refined model. In other cases, the process can include designing the mesostructure such that an inner periphery of the mesostructure conforms to an outer periphery of a surface model that corresponds to and represents the refined model.

In some examples, the process can further include enlarging at least one of the model, the refined model, or the surface model to account for the growth of the individual. Additionally, in some cases, the process can include designing the mesostructure as a latticed structure having a thickness gradient extending from an inner periphery of the mesostructure to an outer periphery of the mesostructure. The process can also include forming the mesostructure using an additive manufacturing technique such as, for instance, three-dimensional (3D) printing in some examples.

### BRIEF DESCRIPTION OF THE DRAWINGS

Many aspects of the present disclosure can be better understood with reference to the following figures. The components in the figures are not necessarily to scale, with emphasis instead being placed upon clearly illustrating the principles of the disclosure. Moreover, repeated use of reference characters or numerals in the figures is intended to represent the same or analogous features, elements, or operations across different figures. Repeated description of such repeated reference characters or numerals is omitted for brevity.

FIG. 1 illustrates a diagram of an example mesostructure helmet according to at least one embodiment of the present disclosure.

FIG. 2 illustrates a diagram of another example mesostructure helmet according to at least one embodiment of the present disclosure.

FIG. 3A illustrates a cross-sectional view of an example mesostructure according to at least one embodiment of the present disclosure.

FIG. 3B illustrates a cross-sectional view of another example mesostructure according to at least one embodiment of the present disclosure.

FIG. 4A illustrates a cross-sectional view of an example substructure according to at least one embodiment of the present disclosure.

FIG. 4B illustrates a cross-sectional view of another example substructure according to at least one embodiment of the present disclosure.

FIG. 5 illustrates a diagram of an example helmet design process according to at least one embodiment of the present disclosure.

FIG. 6 illustrates a diagram of another example helmet design process according to at least one embodiment of the present disclosure.

FIG. 7 illustrates a flow diagram of an example computer-implemented method according to at least one embodiment of the present disclosure.

FIG. 8 illustrates a block diagram of an example computing device according to at least one embodiment of the present disclosure.

### DETAILED DESCRIPTION

As noted above, the use of improperly fitting helmets for children and adults, and its relationship to greater risk of injury, has been continually identified over the last twenty years. Helmet fit, comfort, and stability are all factors that affect how well a helmet will protect an individual's head during an impact. In particular, helmet fit is the driving component for comfort, which can affect whether and how often an individual wears a helmet. Helmet fit is also a factor in how stable a helmet is on a person's head, which affects how well the helmet will protect the person during an impact. Additionally, while fit, comfort, and stability are all important factors that affect the protection provided by a helmet, the helmet material is considered to be the driving component for protection. Specifically, the helmet material that reduces peak linear acceleration is considered to be the material that can provide improved protection during an impact.

Many existing helmets include an inner protective lining formed with expanded polystyrene (EPS) to reduce peak linear acceleration to a person's brain in the event of an impact. However, a problem with such helmets is that the EPS liner is not custom designed to conform to the anthropometric aspects of a person's head. Instead, the EPS liner is formed according to a limited number of standard shapes and sizes. Consequently, for the reasons noted above, individuals who use helmets with such an EPS liner have severe issues with helmet fit, comfort, and stability, which often reduces the degree of protection such helmets provide during an impact.

Some existing helmets developed more recently include an inner protective lining formed as a combination of EPS and a thermoplastic structure, such as an extruded, stacked, or hexagonal (i.e., honeycomb) thermoplastic structure. Additionally, some of these helmets include an inner protective lining formed with only the thermoplastic structure. However, a problem with some thermoplastic structures is that, during an impact, the thermoplastic structure often begins to fail at its outer periphery before the impact force has fully propagated through the structure. This initial failure means that the thermoplastic structure is not fully utilizing its material properties to reduce peak linear acceleration.

The present disclosure provides solutions to address the above-described problems associated with helmets in general and with respect to the existing helmets described above. To overcome such limitations, various examples of the present disclosure describe a mesostructure that is custom formed to conform to the anthropometric aspects of a particular individual's head. Whether used independently as a helmet or combined with an outer shell, the mesostructure described herein provides a personalized and improved fit, comfort, and stability for a particular individual. Such a personalized and improved fit, comfort, and stability can improve the degree of protection provided by the mesostructure during an impact, whether it is used independently as a helmet or combined with an outer shell. For instance, as the personalized mesostructure helmet described herein is relatively better fitting and more comfortable compared to other helmets, it is more likely to be worn and to be in the correct position during a crash, thus leading to improved protection and safety in actual use.

The mesostructure of the present disclosure provides several technical benefits and advantages. For example, as the curvature of an inner periphery of a mesostructure described herein can be custom designed to conform to the anthropometric aspects of a particular user's head, the amount of contact area between the user's head and the mesostructure can be relatively greater compared to existing helmets. As a result of such an increased contact area, the mesostructure of the present disclosure can better distribute the load from an impact, thereby lowering the amount of stress placed on the mesostructure and the user's head. Additionally, the mesostructure of the present disclosure can include a thickness gradient to counter initial material failure that may otherwise occur at the outer periphery of the mesostructure during an impact. Such a functionally graded mesostructure can improve impact performance compared to structures of equal mass included in some existing thermoplastic structures.

In addition, in some cases, a helmet shell can also be incorporated as part of the final design of a mesostructure described herein, to provide additional protection during an impact. For instance, an outer shell can be coupled to an outer periphery of a mesostructure described herein. In one example, the outer shell can be a continuous and contiguous outer shell that can be printed at the outer periphery of the mesostructure such that it is an integral component of the mesostructure. In another example, the outer shell can be designed to break away from the mesostructure in response to an impact, to reduce rotational acceleration to a user's head.

Further, the mesostructures described herein can be formed using an additive manufacturing technique such as, for instance, three-dimensional printing. Using additive manufacturing for production will circumvent slow, traditional design and manufacturing processes. This circumvention will lead to a more agile design process, with greater speed to market. Also, using additive manufacturing circumvents hurdles such as expensive molding costs and navigating international supply chains. Using additive manufacturing also allows for the controlled design and fabrication of a mesostructure having a single type or different types of structures, a mesostructure having regions with different quantities or densities of substructures, and/or a mesostructure having regions that include substructures with different sizes or thicknesses. Such a variety of mesostructure designs provides additional options for personalizing or customizing a mesostructure helmet to achieve relatively better fit, comfort, stability, and protection for a particular user.

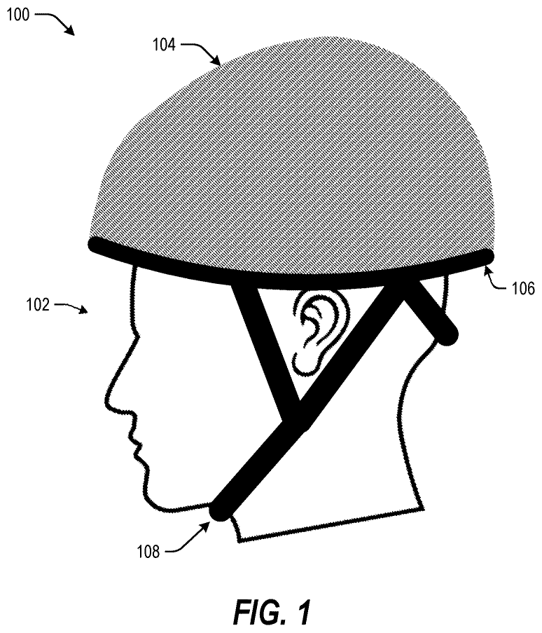

For context, FIG. 1 illustrates a diagram of an example mesostructure helmet 100 according to at least one embodiment of the present disclosure. The mesostructure helmet 100 can be embodied as a custom or personalized-fit helmet for an individual 102. The individual 102 can be a person of any age such as, for instance, an infant, a toddler, a child, a teenager, or an adult. The mesostructure helmet 100 can include a mesostructure 104, a rim 106, and a helmet securing system 108, among other components in some cases. The mesostructure 104 can be embodied as a latticed structure such as, for instance, any latticed structure described herein. The rim 106 can be formed along and coupled to an annular base of the mesostructure 104. The helmet securing system 108 can be coupled to at least one of the mesostructure 104 or the rim 106. In this way, the helmet securing system 108 can be configured and operable to secure the mesostructure helmet 100 to the head of the individual 102.

In one example, the mesostructure 104 can be formed as a Type 1 structure. For instance, the mesostructure 104 can be formed as a Type 1 structure that can include Type 1 substructures. Each of the Type 1 substructures can have an approximately spherical shape (i.e., with an approximately circular shaped cross-section). In one example, the mesostructure 104 can be formed as a Weaire-Phelan Cell structure that can include Type 1 substructures that each have an approximately spherical shape. For example, the Weaire-Phelan Cell structure can include Type 1 substructures that each have an approximately pyritohedron shape, an approximately tetrakaidecahedron shape, or another polyhedron shape that is approximately spherical. The Type 1 substructures of such a Weaire-Phelan Cell structure can be collectively formed as a latticed structure to form the mesostructure 104.

In another example, the mesostructure 104 can include a Type 2 structure. For instance, the mesostructure 104 can be formed as a Type 2 structure that can include Type 2 substructures. Each of the Type 2 substructures can have an approximately diamond shape (i.e., with an approximately diamond shaped cross-section). In one example, the mesostructure 104 can be formed as a Body-Centered Cubic Cell structure that can include Type 2 substructures that each have an approximately diamond shape. The Type 2 substructures of such a Body-Centered Cubic Cell structure can be collectively formed as a latticed structure to form the mesostructure 104.

In yet another example, the mesostructure 104 can be formed as or include an Elongated Kelvin Cell structure or another type of structure or mesostructure. In some cases, the mesostructure 104 can be formed as or include a combination of different structures or mesostructures. For instance, in some cases, the mesostructure 104 can be formed as or include at least one of a Type 1 structure, a Type 2 structure, a latticed structure, a Weaire-Phelan Cell structure, a Body-Centered Cubic Cell structure, an Elongated Kelvin Cell structure, or another structure or mesostructure. In the example illustrated in FIG. 1, the mesostructure 104 can include one or more Type 1 substructures, one or more Type 2 substructures, or a combination thereof.

The mesostructure 104 and the substructures thereof can be formed using one or more materials that can include, but are not limited to, a pure material, an alloy material, a composite material, a polymer material, a plastic material, an elastic material, a thermoplastic material, another material, or any combination thereof. The properties of a material, such as the mechanical properties, can influence which material or materials should be used to form the mesostructure 104 and the substructures thereof. In various examples, one or more materials having a desired elongation to break and impact strength can be used to form the mesostructure 104 and the substructures thereof. In one example, the mesostructure 104 and the substructures thereof can be formed using Nylon PA11. In another example, the mesostructure 104 and the substructures thereof can be formed using Nylon PA12.

In some cases, the substructures of the mesostructure 104 can be formed in a continuous and contiguous fashion throughout the mesostructure 104. In this way, such substructures can collectively form the mesostructure 104 as a single, uniform structure. In other cases, one or more substructures of the mesostructure 104 can be formed in a discontinuous or disconnected fashion in at least one portion of the mesostructure 104. In one example, such one or more substructures can be disconnected from at least one other substructure of the mesostructure 104, thereby forming a gap or a space between the disconnected substructures. In this example, the gap or space can receive one or more components of the mesostructure helmet 100 such as, for instance, the rim 106, the helmet securing system 108, or another component.

In some cases, the mesostructure 104 can be formed such that at least one of the quantity or density of substructures formed in one region of the mesostructure 104 is the same as that of all other regions of the mesostructure 104. In other cases, the mesostructure 104 can be formed such that at least one of the quantity or density of substructures formed in one region of the mesostructure 104 is different from that of one or more other regions of the mesostructure 104.

In some cases, the substructures of the mesostructure 104 can be formed in a linear or uniform fashion throughout the mesostructure 104. For instance, each of the substructures can be formed such that they have at least one of the same shape, size, or thickness throughout the mesostructure 104. In other cases, the substructures of the mesostructure 104 can be formed in a nonlinear or nonuniform fashion in at least one portion of the mesostructure 104. In one example, one or more substructures of the mesostructure 104 can have at least one of a shape, size, or thickness that is different from that of one or more other substructures in the mesostructure 104.

In some cases, one or more substructures of the mesostructure 104 can be individually formed in a linear or uniform fashion. As an example, for a particular substructure of the mesostructure 104, the substructure can be individually formed such that a first end of the substructure has at least one of a size or thickness that is the same as that of a second end of the same substructure. In other cases, one or more substructures of the mesostructure 104 can be individually formed in a nonlinear or nonuniform fashion. As an example, for a particular substructure of the mesostructure 104, the substructure can be individually formed such that a first end of the substructure has at least one of a size or thickness that is greater than or less than that of a second end of the same substructure.

The substructures of the mesostructure 104 can be formed such that they collectively extend from an inner periphery of the mesostructure 104 to an outer periphery of the mesostructure 104, or vice versa in some cases. The inner periphery of the mesostructure 104 can function as an inner contact region of the mesostructure helmet 100. For instance, the inner periphery can function as an inner contact region that contacts one or more parts of the individual 102 when the mesostructure helmet 100 is worn by the individual 102. For example, the inner periphery of the mesostructure 104 can contact at least one of the head, hair, scalp, forehead, temple, skin, or another part of the individual 102 when the mesostructure helmet 100 is worn by the individual 102. The outer periphery of the mesostructure 104 can function as an outer protective region of the mesostructure helmet 100. For instance, the outer periphery can function as an outer protective region similar to an outer protective shell of many existing helmets.

In some cases, the substructures of the mesostructure 104 can be formed such that they collectively extend in a linear or uniform fashion from the above-described inner periphery of the mesostructure 104 to the above-described outer periphery of the mesostructure 104. In one example, such substructures that collectively extend from the inner periphery to the outer periphery of the mesostructure 104 can all have at least one of the same size or thickness. In this example, the substructures that are formed at the inner periphery of the mesostructure 104 can have at least one of the same size or thickness as that of the substructures formed at the outer periphery of the mesostructure 104.

In other cases, the substructures of the mesostructure 104 can be formed such that they collectively extend in a nonlinear or nonuniform fashion from the inner periphery of the mesostructure 104 to the outer periphery of the mesostructure 104. In one example, the substructures that are formed at the inner periphery of the mesostructure 104 can have at least one of a different size or thickness than that of the substructures formed at the outer periphery of the mesostructure 104. For instance, the substructures formed at the inner periphery of the mesostructure 104 can all have at least one of a size or thickness that is less than that of the substructures formed at the outer periphery of the mesostructure 104. In this example, the mesostructure 104 and the substructures thereof that collectively extend in such a nonlinear or nonuniform fashion from the inner periphery to the outer periphery of the mesostructure 104 can therefore have a thickness gradient (also referred to herein as a “graded thickness”).

Additionally, the mesostructure 104 and the substructures thereof can be formed such that they conform to one or more anthropometric aspects of the individual 102 when the mesostructure helmet 100 is worn by the individual 102. For instance, substructures positioned along the inner periphery of the mesostructure 104 can be formed such that they conform to one or more anthropometric aspects of the individual 102 when the mesostructure helmet 100 is worn by the individual 102. Such one or more anthropometric aspects (hereinafter, “the anthropometric aspects”) can include anthropometric aspects of the individual 102 as a whole, anthropometric aspects of the head of the individual 102 (e.g., size, shape, curvature, etc., of the head), anthropometric aspects of one or more anatomical or physical features (e.g., hair, ears, eyes, medical device) located on the head of the individual 102, or any combination thereof.

In one example, the anthropometric aspects described above can include, but are not limited to, the height, weight, and/or limb lengths of the individual 102. In this example, such anthropometric aspects can also include, but are not limited to, the shape, circumference, weight, height, width, and/or topography of the head of the individual 102. In this example, such anthropometric aspects can further include, but are not limited to, the shape, size, and/or location of an ear or ears of the individual 102, as well as the type (e.g., straight or curly), thickness, volume, density, and/or height of the hair of the individual 102 (e.g., the height of the hair as measured from the scalp of the individual 102).

As noted above, the rim 106 can be formed along and coupled to an annular base of the mesostructure 104 such that it can be coupled to the helmet securing system 108 in some cases. The rim 106 can be formed using a rigid material, a flexible material, or a combination thereof. For instance, the rim 106 can be formed using at least one of a pure material, an alloy material, a composite material, a metal material, a polymer material, a plastic material, an elastic material, a thermoplastic material, or another material.

As noted above, the helmet securing system 108 can be coupled to at least one of the mesostructure 104 or the rim 106 such that it can secure the mesostructure helmet 100 to the head of the individual 102. The helmet securing system 108 can also be configured and operable to fine tune one or more custom or personalized features of at least one of the mesostructure helmet 100 of the mesostructure 104. For instance, the helmet securing system 108 can be configured and operable to fine tune the fit and positioning of the mesostructure helmet 100 and the mesostructure 104 on the head of the individual 102. For example, the helmet securing system 108 can be configured and operable to adjust the vertical (i.e., up and down), horizontal (i.e., left, right, forward, and backward), and circumferential (i.e., around the head) fit and positioning of the mesostructure helmet 100 and the mesostructure 104 on the head of the individual 102. The helmet securing system 108 can include at least one of a strap or straps, a fastener device, a tightening device, another helmet securing component, or any combination thereof.

The helmet securing system 108 can include one or more adjustable chin straps (e.g., cloth or textile straps) coupled to an adjustable fastener device (e.g., a male-female clip device, a quick release buckle, or a D-ring unit). The adjustable chin straps and adjustable fastener device can be collectively configured and operable to allow for securing and adjusting the fit and positioning of the mesostructure helmet 100 and the mesostructure 104 on the head of the individual 102. In another example, the helmet securing system 108 can include one or more adjustable head straps (e.g., cloth or textile straps) coupled to a tightening device (e.g., a ratcheting device). The adjustable head straps and tightening device can be collectively configured and operable to allow for tightening and adjusting the circumferential fit and positioning of the mesostructure helmet 100 and the mesostructure 104 around the circumference of the head of the individual 102.

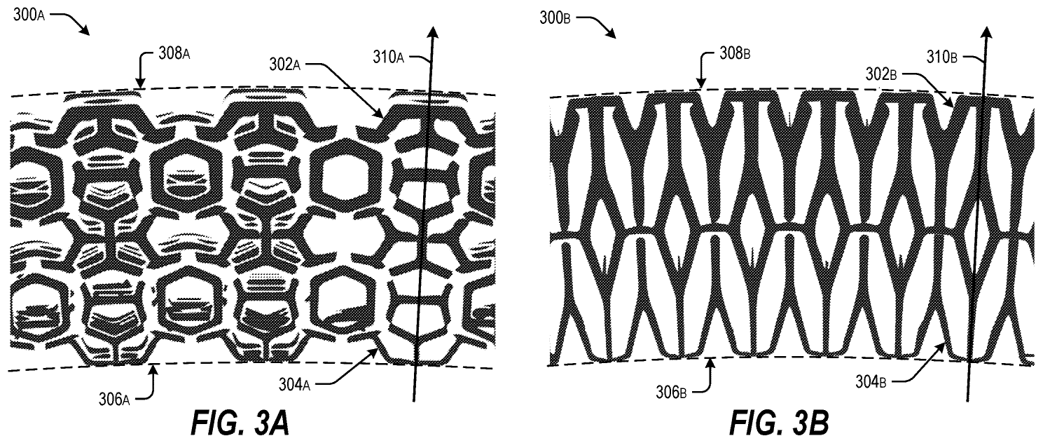

In the example illustrated in FIG. 1, the helmet securing system 108 is coupled to the rim 106 of the mesostructure helmet 100. However, the mesostructure helmets of the present disclosure are not so limited. For example, in some cases, the helmet securing system 108 can be coupled directly or indirectly to one or more regions and/or substructures of the mesostructure 104. For instance, the helmet securing system 108 can be coupled directly or indirectly to at least one Type 1 substructure of the mesostructure 104 in some cases or at least one Type 2 substructure of the mesostructure 104 in other cases. In one example, the helmet securing system 108 can be coupled directly or indirectly to one or more substructures 302a, 304a, 302b, 304b described below and illustrated in FIGS. 3A and 3B.

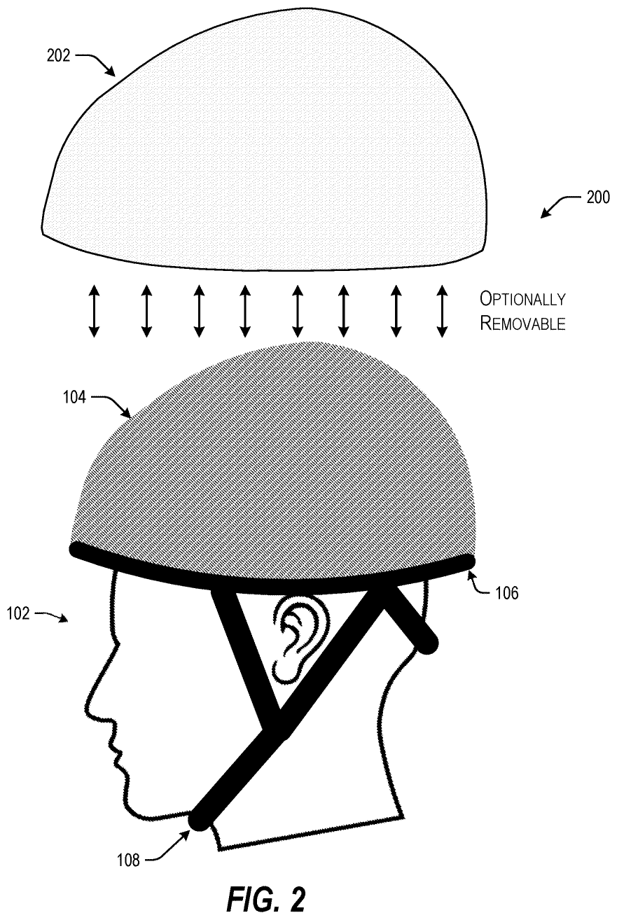

FIG. 2 illustrates a diagram of another example mesostructure helmet 200 according to at least one embodiment of the present disclosure. The mesostructure helmet 200 is an example of an alternative embodiment of the mesostructure helmet 100 described above with reference to FIG. 1. In the example depicted in FIG. 2, the mesostructure helmet 200 can include any or all of the components of the mesostructure helmet 100. For instance, the mesostructure helmet 200 can include the mesostructure 104, the rim 106, and the helmet securing system 108 in this example. As such, the mesostructure helmet 200 can include the same components, materials, attributes, structure, and functionality as that of the mesostructure helmet 100. In addition to the mesostructure 104, the rim 106, and the helmet securing system 108, the mesostructure helmet 200 can also include an outer shell 202, among other components in some cases.

In one example, the outer shell 202 can be embodied and implemented as a removable outer shell that can be removed from the mesostructure helmet 200. In this example, the outer shell 202 can be attached to and released from the mesostructure helmet 200 by way of an attach and release device or system that can be coupled to the mesostructure helmet 200. In another example, the outer shell 202 can be embodied and implemented as a break-away outer shell that can break away from the mesostructure helmet 200 in response to an impact force applied to the outer shell 202. In this example, the outer shell 202 can be attached to and break away from the mesostructure helmet 200 by way of an attach and break away device or system that can be coupled to the mesostructure helmet 200.

In yet another example, the outer shell 202 can be embodied and implemented as a fixed outer shell that can be permanently coupled to at least one of the mesostructure 104, the rim 106, the helmet securing system 108, or another component of the mesostructure helmet 200. For instance, in some cases, the outer shell 202 can be formed continuously and contiguously with the outer periphery of the mesostructure 104 such that the outer shell 202 is integral with the outer periphery and the mesostructure 104. In another example, at least one of the mesostructure 104 or the helmet securing system 108 can be coupled to an inner surface of the outer shell 202.

The outer shell 202 can be formed using a rigid material, a flexible material, or a combination thereof. For instance, the outer shell 202 can be formed using at least one of a pure material, an alloy material, a composite material, a metal material, a polymer material, a plastic material, an elastic material, a thermoplastic material, or another material. In one example, the outer shell 202 can be formed using polycarbonate. In another example, the outer shell 202 can be formed using fiber glass.

FIG. 3A illustrates a cross-sectional view of an example mesostructure 300a according to at least one embodiment of the present disclosure. The mesostructure 300a is an example embodiment of the mesostructure 104 that can be included with either or both of the mesostructure helmets 100, 200 described above with reference to FIGS. 1 and 2, respectively. As such, the mesostructure 300a can include the same components, material, attributes, structure, and functionality as that of the mesostructure 104. Similarly, in one example, the mesostructure 104 can include the same components, material, attributes, structure, and functionality as that of the mesostructure 300a.

As illustrated in FIG. 3A, the mesostructure 300a can be embodied as a Weaire-Phelan Cell structure. The mesostructure 300a can include a plurality of substructures 302a, 304a (only a single instance of each of the substructures 302a, 304a are denoted in FIG. 3A for clarity). Each of the substructures 302a, 304a can be embodied as a Type 1 structure. The substructures 302a, 304a are example embodiments of the substructures of the mesostructure 104 described above with reference to FIG. 1. As such, the substructures 302a, 304a can each include the same components, material, attributes, structure, and functionality as that of the substructures of the mesostructure 104. Similarly, in one example, the substructures of the mesostructure 104 can each include the same components, material, attributes, structure, and functionality as that of the substructures 302a, 304a.

The substructures 302a positioned along an outer portion of the mesostructure 300a can form an outer periphery 308a of the mesostructure 300a. The outer periphery 308a of the mesostructure 300a is an example embodiment of the outer periphery of the mesostructure 104 described above with reference to FIG. 1. The substructures 304a positioned along an inner portion of the mesostructure 300a can form an inner periphery 306a of the mesostructure 300a. The inner periphery 306a of the mesostructure 300a is an example embodiment of the inner periphery of the mesostructure 104 described above with reference to FIG. 1.

In the example depicted in FIG. 3A, the substructures of the mesostructure 300a, including the substructures 302a, 304a, collectively extend in a radial direction 310a from the inner periphery 306a to the outer periphery 308a. As shown in FIG. 3A, such substructures collectively extend along the radial direction 310a in a nonlinear or nonuniform fashion, as the thickness of such substructures increases from the inner periphery 306a to the outer periphery 308a. In this example, the substructures 302a positioned along the outer periphery 308a have a thickness that is greater than that of the substructures 304a positioned along the inner periphery 306a. In this way, the mesostructure 300a and the substructures thereof, including the substructures 302a, 304a, have a thickness gradient (graded thickness) that is thinner at the inner periphery 306a and thicker at the outer periphery 308a in this example.

It should be appreciated that the thickness gradient described above can provide improved impact protection during a dynamic loading event compared to existing helmets. In particular, compared to existing helmets, the thickness gradient provides better propagation of linear (i.e., straight) and rotational impact forces through the substructures of the mesostructure 300a when such forces are applied directly or indirectly to the outer periphery 308a of the mesostructure 300a. By providing improved propagation of such impact forces (i.e., improved force dispersion) through the substructures of the mesostructure 300a, the thickness gradient can thereby reduce at least one of peak linear acceleration or rotational acceleration resulting from such impact forces.

In some cases, the above-described thickness gradient can be a stepped thickness gradient. In these cases, each individual substructure of the mesostructure 300a, including each of the substructures 302a, 304a, can have a uniform thickness. For example, the substructures 302a can each have a first uniform thickness and the substructures 304a can each have a second uniform thickness that is greater than the first uniform thickness of each of the substructures 302a. In this example, any substructure positioned between the substructures 302a and the substructures 304a along the radial direction 310a can have a uniform thickness that is greater than the first uniform thickness of the substructures 302a and less than the second uniform thickness of the substructures 304a. In this way, the mesostructure 300a and the substructures thereof, including the substructures 302a, 304a, have a stepped thickness gradient (graded thickness) that is thinner at the inner periphery 306a and thicker at the outer periphery 308a.

FIG. 3B illustrates a cross-sectional view of another example mesostructure 300b according to at least one embodiment of the present disclosure. The mesostructure 300b is another example embodiment of the mesostructure 104 that can be included with either or both of the mesostructure helmets 100, 200 described above with reference to FIGS. 1 and 2, respectively. As such, the mesostructure 300b can include the same components, material, attributes, structure, and functionality as that of the mesostructure 104. Similarly, in one example, the mesostructure 104 can include the same components, material, attributes, structure, and functionality as that of the mesostructure 300b.

As illustrated in FIG. 3B, the mesostructure 300b can be embodied as a Body-Centered Cubic Cell structure. The mesostructure 300b can include a plurality of substructures 302b, 304b (only a single instance of each of the substructures 302b, 304b are denoted in FIG. 3B for clarity). Each of the substructures 302b, 304b can be embodied as a Type 2 structure. The substructures 302b, 304b are example embodiments of the substructures of the mesostructure 104 described above with reference to FIG. 1. As such, the substructures 302b, 304b can each include the same components, material, attributes, structure, and functionality as that of the substructures of the mesostructure 104. Similarly, in one example, the substructures of the mesostructure 104 can each include the same components, material, attributes, structure, and functionality as that of the substructures 302b, 304b.

The substructures 302b positioned along an outer portion of the mesostructure 300b can form an outer periphery 308b of the mesostructure 300b. The outer periphery 308b of the mesostructure 300b is an example embodiment of the outer periphery of the mesostructure 104 described above with reference to FIG. 1. The substructures 304b positioned along an inner portion of the mesostructure 300b can form an inner periphery 306b of the mesostructure 300b. The inner periphery 306b of the mesostructure 300b is an example embodiment of the inner periphery of the mesostructure 104 described above with reference to FIG. 1.

In the example depicted in FIG. 3B, the substructures of the mesostructure 300b, including the substructures 302b, 304b, collectively extend in a radial direction 310b from the inner periphery 306b to the outer periphery 308b. As shown in FIG. 3B, such substructures collectively extend along the radial direction 310b in a nonlinear or nonuniform fashion, as the thickness of such substructures increases from the inner periphery 306b to the outer periphery 308b. In this example, the substructures 302b positioned along the outer periphery 308b have a thickness that is greater than that of the substructures 304b positioned along the inner periphery 306b. In this way, the mesostructure 300b and the substructures thereof, including the substructures 302b, 304b, have a thickness gradient (graded thickness) that is thinner at the inner periphery 306b and thicker at the outer periphery 308b in this example.

It should be appreciated that the thickness gradient described above can provide improved impact protection during a dynamic loading event compared to existing helmets. In particular, compared to existing helmets, the thickness gradient provides better propagation of linear (i.e., straight) and rotational impact forces through the substructures of the mesostructure 300b when such forces are applied directly or indirectly to the outer periphery 308b of the mesostructure 300b. By providing improved propagation of such impact forces (i.e., improved force dispersion) through the substructures of the mesostructure 300b, the thickness gradient can thereby reduce at least one of peak linear acceleration or rotational acceleration resulting from such impact forces.

The above-described thickness gradient can be a stepped thickness gradient in some cases. In these cases, each individual substructure of the mesostructure 300b, including each of the substructures 302b, 304b, can have a uniform thickness. For example, the substructures 302b can each have a first uniform thickness and the substructures 304b can each have a second uniform thickness that is greater than the first uniform thickness of each of the substructures 302b. In this example, any substructure positioned between the substructures 302b and the substructures 304b along the radial direction 310b can have a uniform thickness that is greater than the first uniform thickness of the substructures 302b and less than the second uniform thickness of the substructures 304b. In this way, the mesostructure 300b and the substructures thereof, including the substructures 302b, 304b, have a stepped thickness gradient (graded thickness) that is thinner at the inner periphery 306b and thicker at the outer periphery 308b in this example.

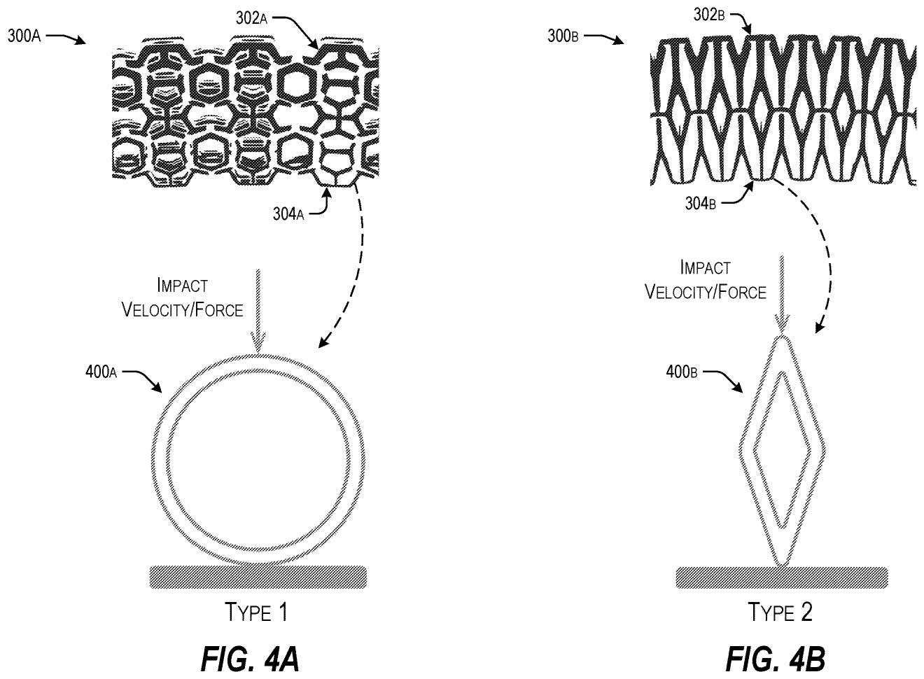

FIG. 4A illustrates a cross-sectional view of an example substructure 400a according to at least one embodiment of the present disclosure. The substructure 400a is an example embodiment of a Type 1 substructure described herein. In particular, in the example shown in FIG. 4A, the substructure 400a is an example embodiment of at least one of the substructures 302a, 304a of the mesostructure 300a described above with reference to FIG. 3A.

FIG. 4B illustrates a cross-sectional view of another example substructure 400b according to at least one embodiment of the present disclosure. The substructure 400b is an example embodiment of a Type 2 substructure described herein. In particular, in the example shown in FIG. 4B, the substructure 400b is an example embodiment of at least one of the substructures 302b, 304b of the mesostructure 300b described above with reference to FIG. 3B.

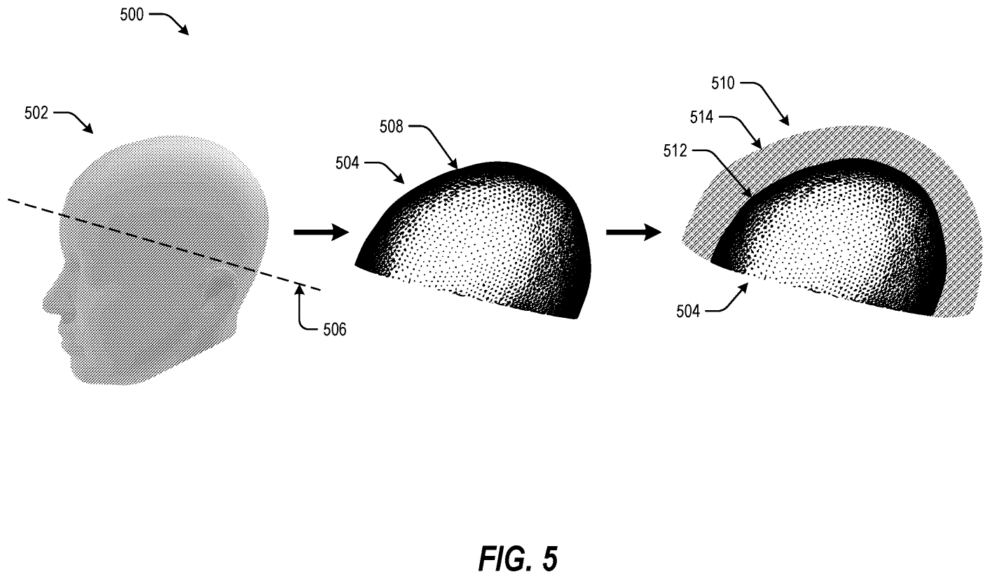

FIG. 5 illustrates a diagram of an example helmet design process 500 according to at least one embodiment of the present disclosure. The helmet design process 500 can be implemented to design any of the mesostructure helmets and mesostructures described herein. For instance, the helmet design process 500 can be implemented to design at least one of the mesostructure helmet 100, the mesostructure helmet 200, the mesostructure 104, the mesostructure 300a, or the mesostructure 300b. Additionally, the helmet design process 500 can be implemented to customize or personalize any of the mesostructure helmets and mesostructures described herein for a particular individual. For example, the helmet design process 500 can be implemented to customize or personalize any of the mesostructure helmets and mesostructures described herein such that the resulting helmet provides at least one of improved fit, comfort, stability, or protection for a particular individual when compared to existing helmets.

The helmet design process 500 can include generating a model 502 of anthropometric aspects of a head of an individual. For example, the helmet design process 500 can include using at least one of a photo-based or scanning-based device, application, or process to generate the model 502 of anthropometric aspects of a head of an individual. The model 502 can be embodied as a 2-dimensional (2D) or 3-dimensional (3D) photo, image, point cloud, mesh, or scan of the anthropometric aspects of an individual's head.

In one example, the helmet design process 500 can include using a photo-based device (e.g., a computing device with a camera) and a photo-based application (i.e., photo-based software) to generate the model 502 using one or more photos or images of an individual's head. For example, a computing device such as, for instance, a computer, a laptop, a tablet, a smartphone, or another computing device can be used to capture or otherwise obtain one or more photos or images of the individual's head. The computing device can then be used to implement a photogrammetry application (i.e., photogrammetry software) to generate the model 502 based on such photos or images. The photogrammetry application can be included in the computing device in some cases or can be accessed using the computing device in other cases.

In another example, the helmet design process 500 can include using a scanning-based device (e.g., a computing device with a scanner) and a scanning-based application (i.e., scanning-based software) to generate the model 502 using a scan of an individual's head. For example, a 3D scanning device (e.g., a 3D scanner) and a 3D scanning application (i.e., 3D scanning software) can be used to capture visual data (e.g., 3D visual data) indicative of the individual's head. The 3D scanning device and 3D scanning application can then be used to create a 3D point cloud or 3D mesh to represent the captured visual data indicative of the individual's head. Next, the 3D scanning device and 3D scanning application can be used to generate the model 502 based on the 3D point cloud or 3D mesh.

When collecting anthropometric data indicative of an individual's head, in order to limit the presence of hair artifacts, the individual can wear a fit cap. For instance, the individual can wear a swimmer's cap or another cap to conceal their hair. Wearing a fit cap can reduce the prevalence of hair artifacts in the model 502, as well as give a more accurate presentation of the individual's head size and shape. In cases where a fit cap is not used, the helmet design process 500 can further include using a computing device described herein to implement an application (i.e., software) to predict the size and shape of an individual's head.

The helmet design process 500 can further include editing the model 502 to generate a refined model 504 of the anthropometric aspects of the individual's head. For example, the helmet design process 500 can include using a computing device described herein and a model editing application such as, for instance, a parametric modeling application (i.e., parametric modeling software) to edit the model 502, thereby generating the refined model 504. In this example, the computing device can be used to implement the parametric modeling application to edit a 3D point cloud or 3D mesh that is representative of the model 502.

In one example, editing the model 502 to generate the refined model 504 can include removing at least one of an excess feature or an artifact from the model 502. For instance, the parametric modeling application can be used to remove excess features or artifacts that can include, but are not limited to, the eyes, ears, hair, back of the head, and another feature or artifact. In another example, editing the model 502 to generate the refined model 504 can include adjusting the model 502 to account for one or more anatomical features of at least one of the head or the individual.

In another example, editing the model 502 to generate the refined model 504 can include isolating a region of the model 502 that corresponds to an area of the head that is to be protected by a mesostructure and/or a mesostructure helmet of the present disclosure. For instance, as illustrated in FIG. 5, the parametric modeling application can be used to isolate a region such as, for example, any or all of the cranium region of the model 502. In this example, the parametric modeling application can be used to separate the model 502 along a plane 506 to isolate the cranium region of the individual's head from the model 502.

In another example, editing the model 502 to generate the refined model 504 can include adjusting the model 502 to account for growth of the individual. For example, the parametric modeling application can be used to enlarge one or more sections of the model 502 to account for growth of the individual. In this example, the parametric modeling application can be used to enlarge any or all of the model 502 based on human growth patterns such as, for instance, pediatric growth patterns. In some cases, to account for growth of the individual, the parametric modeling application can be used to enlarge one or more sections of the refined model 504. For example, the parametric modeling application can be used to enlarge any or all of the refined model 504 based on human growth patterns such as, for instance, pediatric growth patterns.

Based on editing the model 502 using one or more of the above-described editing techniques, another editing technique, or a combination thereof, the resulting refined model 504 can include an outer periphery 508. In one example, the outer periphery 508 can correspond to, represent, and include the current (i.e., present day) anthropometric aspects of the region of the individual's head that is to be protected, such as any or all of the individual's cranium region. In another example, the outer periphery 508 can correspond to, represent, and include predicted anthropometric aspects of the region of the individual's head that is to be protected, such as any or all of the individual's cranium region. The predicted anthropometric aspects can be predicted using human or pediatric growth patterns. Based on such growth patterns, the parametric modeling application can be used to enlarge the refined model 504 such that the outer periphery 508 corresponds to, represents, and includes the predicted anthropometric aspects of the region of the individual's head that is to be protected.

The helmet design process 500 can also include designing a mesostructure 510 based on the refined model 504. In addition, the helmet design process 500 can include using the refined model 504 to design the mesostructure 510 such that it can reduce peak linear acceleration during an impact. In one example, the mesostructure 510 can be an example embodiment of any mesostructure described herein such as, for instance, the mesostructure 104, the mesostructure 300a, or the mesostructure 300b described above with reference to FIGS. 1, 3A, and 3B. Additionally, in this example, the mesostructure 510 can include the same components, material, attributes, structure, and functionality as that of any of such mesostructures described herein.

To design the mesostructure 510 based on the refined model 504, the helmet design process 500 can include designing an inner periphery 512 of the mesostructure 510 to conform to the outer periphery 508 of the refined model 504. The inner periphery 512 of the mesostructure 510 can function as an inner contact region that contacts the individual's head when the mesostructure 510 is worn by the individual. In one example, the helmet design process 500 can include using a computing device described herein and a generative design application (i.e., generative design software) to design the mesostructure 510 such that the inner periphery 512 of the mesostructure 510 conforms to the outer periphery 508 of the refined model 504. In this way, the inner periphery 512 of the mesostructure 510 can be designed such that it conforms to the above-described current or predicted anthropometric aspects of the region of the individual's head that is to be protected.

To design the mesostructure 510 such that it can reduce peak linear acceleration during an impact, the mesostructure 510 can be designed to include a thickness gradient (graded thickness) extending from the inner periphery 512 to an outer periphery 514 of the mesostructure 510. The outer periphery 514 of the mesostructure 510 can function as an outer protective region of the mesostructure 510, similar to an outer protective shell of many existing helmets. In one example, the helmet design process 500 can include using a field-driven design feature or tool of the generative design application such as, for instance, ramp block to design the mesostructure 510 such that it includes such a thickness gradient. In this example, the field-driven design feature or tool of the generative design application can be used to design the mesostructure 510 such that it includes a thickness gradient that extends, and increases in thickness, from the inner periphery 512 to the outer periphery 514 of the mesostructure 510, or vice versa in some cases. In one example, the generative design application can be implemented to design the mesostructure 510 such that it includes the thickness gradient described above with reference to FIG. 3A that can extend from the inner periphery 306a to the outer periphery 308a of the mesostructure 300a.

To design the mesostructure 510 such that it includes the thickness gradient described above, the generative design application can be used to design a latticed structure of graded thickness. Examples of such a latticed structure having a graded thickness can include, but are not limited to, a latticed Type 1 structure of graded thickness, a latticed Type 2 structure of graded thickness, a Weaire-Phelan structure of graded thickness, an Elongated Kelvin cell structure of graded thickness, and a Body-Centered Cubic Cell structure of graded thickness.

In one example, the generative design application can be used to design the latticed structure such that it includes a first subset of substructures (e.g., Type 1 or Type 2) positioned along the inner periphery 512 of the mesostructure 510 and a second subset of substructures (e.g., Type 1 or Type 2) positioned along the outer periphery 514 of the mesostructure 510. Additionally, in this example, the generative design application can be used to design the latticed structure such that it includes a third subset of substructures (e.g., Type 1 or Type 2) positioned between the first and second subsets of substructures. In this example, the generative design application can be used to design the first, second, and third subsets of substructures such that the thickness of the second subset of substructures is greater than that of the third subset of substructures and the thickness of the third subset of substructures is greater than that of the first subset of substructures. In this way, the mesostructure 510 can be designed such that it includes a thickness gradient (graded thickness) that is thinner at the inner periphery 512 and thicker at the outer periphery 514 of the mesostructure 510 in this example.

Although not illustrated in FIG. 5, in some cases, the helmet design process 500 can further include performing at least one of static or dynamic simulations on the mesostructure 510 such as, for instance, static and/or dynamic finite element analysis (FEA). In these cases, the helmet design process 500 can also include modifying or completely redesigning an initial or previous design of the mesostructure 510 based on the results of such simulations.

In some cases, the complexity of the mesostructure 510, or any of the mesostructures described herein, may be too computationally intensive for static and/or dynamic FEA alone to produce any meaningful results. In these cases, although not illustrated in FIG. 5, the helmet design process 500 can further include performing a homogenization process paired with impact testing for downselection. In these cases, homogenization is a computational process that includes analyzing one unit cell (e.g., a homogenized unit cell) of the mesostructure 510 to understand the material properties of the mesostructure 510. In these cases, the helmet design process 500 can further include performing static and/or dynamic FEA on one unit cell of the mesostructure 510 to understand the material properties of the mesostructure 510. In these cases, to perform downselection, the homogenization process can be used to rank the relative performance of each analyzed unit cell. Once downselection for unit cells has been achieved in these cases, the mesostructure 510 can be produced and impact tested to evaluate for absolute performance.

Accordingly, although not illustrated in FIG. 5, in some cases, the helmet design process 500 can further include forming the mesostructure 510 as a latticed structure of graded thickness using one or more of an additive manufacturing device or technique. For instance, in some cases, the helmet design process 500 can include using at least one of a 3D printing device (e.g., a 3D printer), application, or process to fabricate the mesostructure 510 as a latticed structure of graded thickness. For example, in some cases, the helmet design process 500 can include using such a 3D printing device, application, and/or process to fabricate the mesostructure 510 as a latticed Type 2 structure of graded thickness, a Weaire-Phelan structure of graded thickness, an Elongated Kelvin cell structure of graded thickness, a Body-Centered Cubic Cell structure of graded thickness, another latticed structure of graded thickness, or a combination thereof.

Further, although not illustrated in FIG. 5, in some cases, the helmet design process 500 can also include impact testing a fabricated mesostructure 510. In these cases, the helmet design process 500 can also include modifying or completely redesigning an initial or previous design of the mesostructure 510 based on the results of such impact testing.

In addition, although not illustrated in FIG. 5, in some cases, the helmet design process 500 can further include positioning a fabricated mesostructure 510 on the individual's head and assessing at least one of the fit, comfort, or stability of the fabricated mesostructure 510 from the perspective of the individual. In these cases, the helmet design process 500 can also include modifying or completely redesigning an initial or previous design of the mesostructure 510 based on feedback received from the individual related to at least one of the fit, comfort, or stability of the fabricated mesostructure 510.

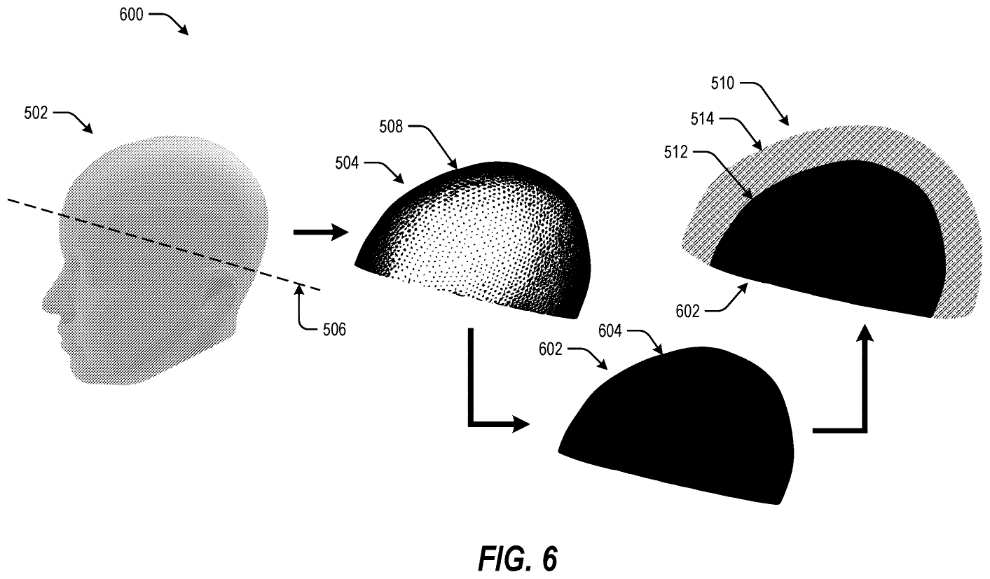

FIG. 6 illustrates a diagram of another example helmet design process 600 according to at least one embodiment of the present disclosure. The helmet design process 600 is an example of an alternative embodiment of the helmet design process 500 described above with reference to FIG. 5. The difference between the helmet design process 500 and the helmet design process 600 is that the helmet design process 600 can include designing the mesostructure 510 based on a surface model 602, instead of the refined model 504 as described in the helmet design process 500. For example, the helmet design process 600 can include designing the inner periphery 512 of the mesostructure 510 to conform to an outer periphery 604 of the surface model 602, instead of the outer periphery 508 of the refined model 504 as described in the helmet design process 500. In this example, the outer periphery 604 can include the same features, shape, size, dimensions, and topography as that of the outer periphery 508 of the redefined model 504. In this way, the outer periphery 604 can correspond to, represent, and include the above-described current or predicted anthropometric aspects of the region of the individual's head that is to be protected, such as any or all of the individual's cranium region.

In one example, the surface model 602 can be embodied as or include a T-spline surface that can be generated based on the refined model 504 by using the parametric modeling application noted above with reference to FIG. 5. To generate the surface model 602 in this example, the helmet design process 600 can include implementing the parametric modeling application to create a T-spline surface using a 3D point cloud or 3D mesh representation of the refined model 504. For instance, the surface model 602 can be generated using one or more “form” and/or “pull” tools or commands of the parametric modeling application to create and manipulate a digital geometric object (e.g., a cylinder) around a 3D mesh representation of the refined model 504. In this example, the digital geometric object can be manipulated (e.g., pushed, pulled, expanded, reduced) to conform to at least one of the refined model 504 or the outer periphery 508 of the refined model 504.

Once the surface model 602 has been generated, the helmet design process 600 can further include designing the mesostructure 510 based on the surface model 602 such that the mesostructure 510 can reduce peak linear acceleration during an impact. For example, the helmet design process 600 can include using the generative design application noted above with reference to FIG. 5 to design the inner periphery 512 of the mesostructure 510 to conform to the outer periphery 604 of the surface model 602. In this way, the inner periphery 512 of the mesostructure 510 can be designed such that it conforms to the above-described current or predicted anthropometric aspects of the region of the individual's head that is to be protected.

Additionally, to reduce peak linear acceleration during an impact, the helmet design process 600 can include using the generative design application to design the mesostructure 510 such that it includes a thickness gradient (graded thickness) extending from the inner periphery 512 to the outer periphery 514 of the mesostructure 510. In one example, the helmet design process 600 can include using the generative design application to design the mesostructure 510 such that it includes the thickness gradient described above with reference to FIG. 5. In this example, the helmet design process 600 can include using the generative design application to design such a thickness gradient of the mesostructure 510 in the same manner as described above with reference to FIG. 5.

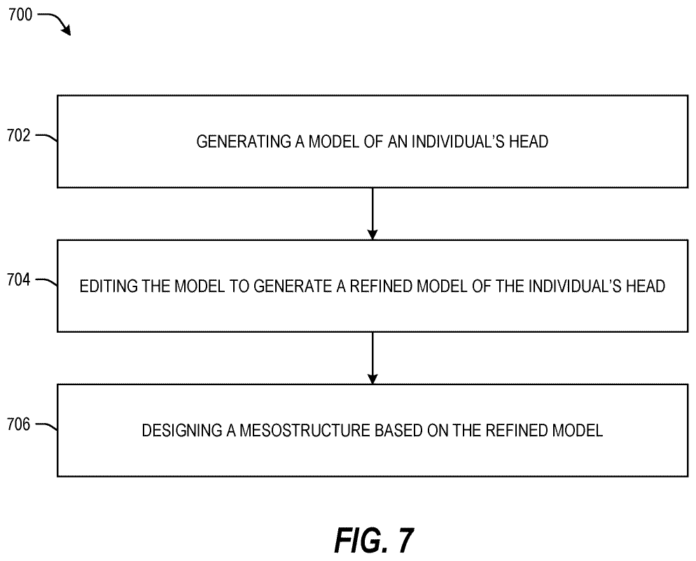

FIG. 7 illustrates a flow diagram of an example computer-implemented method 700 according to at least one embodiment of the present disclosure. In one example, the computer-implemented method 700 (hereinafter, “the method 700”) can be implemented to design any of the mesostructure helmets and mesostructures described herein. For instance, the method 700 can be implemented to design at least one of the mesostructure helmet 100, the mesostructure helmet 200, the mesostructure 104, the mesostructure 300a, the mesostructure 300b, or the mesostructure 510. Additionally, the method 700 can be implemented to customize or personalize any of the mesostructure helmets and mesostructures described herein for a particular individual. For example, the method 700 can be implemented to customize or personalize any of the mesostructure helmets and mesostructures described herein such that the resulting helmet provides at least one of improved fit, comfort, stability, or protection for a particular individual when compared to existing helmets.

At 702, the method 700 can include generating a model of an individual's head. For example, as described above with reference to FIG. 5, the model 502 of anthropometric aspects of an individual's head can be generated using a scanning technique such as, for instance, photogrammetry or 3D scanning.

At 704, the method 700 can include editing the model to generate a refined model of the individual's head. For example, as described above with reference to FIG. 5, the model 502 can be edited using a parametric modeling application to generate the refined model 504 of the anthropometric aspects of the individual's head. In some cases, the method 700 can further include using the parametric modeling application to generate the surface model 602 based on the refined model 504 as described above with reference to FIG. 6. In these cases, the surface model 602 and the outer periphery 604 of the surface model 602 can be generated such that they correspond to, represent, and include the anthropometric aspects of the region of the individual's head that is to be protected, such as any or all of the cranium region.

At 706, the method 700 can include designing a mesostructure based on the refined model. For example, as described above with reference to FIG. 5, a generative design application can be used to design the mesostructure 510 based on the refined model 504. For instance, the mesostructure 510 can be designed such that the inner periphery 512 of the mesostructure 510 conforms to the outer periphery 508 of the refined model 504. Additionally, the mesostructure 510 can be designed such that it includes a thickness gradient extending from the inner periphery 512 to the outer periphery 514 of the mesostructure 510 as described above with reference to FIG. 5. In this way, the mesostructure 510 can be designed such that it reduces peak linear acceleration during an impact. In some cases, the method 700 can include using the parametric modeling application and the generative design application to design the mesostructure 510 such that it conforms to the outer periphery 604 of the surface model 602, instead of the outer periphery 508 of the refined model 504, as described above with reference to FIG. 6.

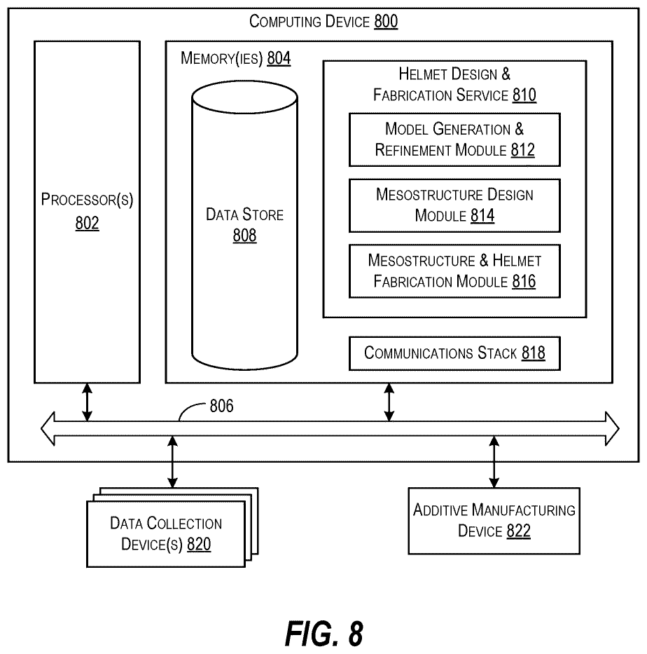

FIG. 8 illustrates a block diagram of an example computing device 800 according to at least one embodiment of the present disclosure. The computing device 800 can be used to design and/or fabricate any of the mesostructure helmets and mesostructures described herein. In one example, the computing device 800 can be used to design and/or fabricate at least one of the mesostructure helmet 100, the mesostructure helmet 200, the mesostructure 104, the mesostructure 300a, the mesostructure 300b, or the mesostructure 510. To design and/or fabricate such mesostructure helmets and/or mesostructures, the computing device 800 can be used to perform one or more of the helmet design process 500, the helmet design process 600, or the method 700.

The computing device 800 can include at least one processing system, for example, having at least one processor 802 and at least one memory 804, both of which can be coupled (e.g., communicatively, electrically, operatively) to a local interface 806. The memory 804 can include a data store 808, a helmet design and fabrication service 810, a model generation and refinement module 812, a mesostructure design module 814, a mesostructure and helmet fabrication module 816, and a communications stack 818 in the example shown. The computing device 800 can be coupled to one or more data collection devices 820 (hereinafter, “the data collection devices 820”) and an additive manufacturing device 822. The computing device 800 can also include other components that are not illustrated in FIG. 8. In some cases, the computing device 800 may or may not include all the components illustrated in FIG. 8. For example, in some cases, depending on how the computing device 800 is embodied or implemented, the memory 804 may or may not include at least one of the helmet design and fabrication service 810, the model generation and refinement module 812, the mesostructure design module 814, the mesostructure and helmet fabrication module 816, or other components.

The processor 802 can include any processing device (e.g., a processor core, a microprocessor, an application specific integrated circuit (ASIC), a field-programmable gate array (FPGA), a controller, a microcontroller, or a quantum processor) and can include one or multiple processors that can be operatively connected. In some examples, the processor 802 can include one or more complex instruction set computing (CISC) microprocessors, one or more reduced instruction set computing (RISC) microprocessors, one or more very long instruction word (VLIW) microprocessors, or one or more processors that are configured to implement other instruction sets.

The memory 804 can be embodied as one or more memory devices and store data and software or executable-code components executable by the processor 802. For example, the memory 804 can store executable-code components associated with the helmet design and fabrication service 810, the model generation and refinement module 812, the mesostructure design module 814, the mesostructure and helmet fabrication module 816, and the communications stack 818 for execution by the processor 802. The memory 804 can also store data such as the data described below that can be stored in the data store 808, among other data. For instance, the memory 804 can also store at least one of the anthropometric aspects of an individual (e.g., the individual 102), the model 502, the refined model 504, or the surface model 602 described above with reference to FIGS. 1, 5, and 6.

The memory 804 can store other executable-code components for execution by the processor 802. For example, an operating system can be stored in the memory 804 for execution by the processor 802. Where any component discussed herein is implemented in the form of software, any one of a number of programming languages can be employed such as, for example, C, C++, C#, Objective C, JAVA®, JAVASCRIPT®, Perl, PHP, VISUAL BASIC®, PYTHON®, RUBY, FLASH®, or other programming languages.

As discussed above, the memory 804 can store software for execution by the processor 802. In this respect, the terms “executable” or “for execution” refer to software forms that can ultimately be run or executed by the processor 802, whether in source, object, machine, or other form. Examples of executable programs include, for instance, a compiled program that can be translated into a machine code format and loaded into a random access portion of the memory 804 and executed by the processor 802, source code that can be expressed in an object code format and loaded into a random access portion of the memory 804 and executed by the processor 802, source code that can be interpreted by another executable program to generate instructions in a random access portion of the memory 804 and executed by the processor 802, or other executable programs or code.

The local interface 806 can be embodied as a data bus with an accompanying address/control bus or other addressing, control, and/or command lines. In part, the local interface 806 can be embodied as, for instance, an on-board diagnostics (OBD) bus, a controller area network (CAN) bus, a local interconnect network (LIN) bus, a media oriented systems transport (MOST) bus, ethernet, or another network interface.

The data store 808 can include data for the computing device 800 such as, for instance, one or more unique identifiers for the computing device 800, digital certificates, encryption keys, session keys and session parameters for communications, and other data for reference and processing. The data store 808 can also store computer-readable instructions for execution by the computing device 800 via the processor 802, including instructions for the helmet design and fabrication service 810, the model generation and refinement module 812, the mesostructure design module 814, the mesostructure and helmet fabrication module 816, and the communications stack 818. In some cases, the data store 808 can also store at least one of the anthropometric aspects of an individual (e.g., the individual 102), the model 502, the refined model 504, or the surface model 602 described above with reference to FIGS. 1, 5, and 6.

The helmet design and fabrication service 810 can be embodied as one or more software applications or services executing on the computing device 800. For example, the helmet design and fabrication service 810 can be embodied as and can include the model generation and refinement module 812, the mesostructure design module 814, the mesostructure and helmet fabrication module 816, and other executable modules or services. The helmet design and fabrication service 810 can be executed by the processor 802 to implement at least one of the model generation and refinement module 812, the mesostructure design module 814, or the mesostructure and helmet fabrication module 816. Each of the model generation and refinement module 812, the mesostructure design module 814, and the mesostructure and helmet fabrication module 816 can also be respectively embodied as one or more software applications or services executing on the computing device 800. In one example, the helmet design and fabrication service 810 can be executed by the processor 802 to design and fabricate at least one of the mesostructure helmet 100, the mesostructure helmet 200, the mesostructure 104, the mesostructure 300a, the mesostructure 300b, or the mesostructure 510 using the model generation and refinement module 812, the mesostructure design module 814, and the mesostructure and helmet fabrication module 816 as described herein.

The model generation and refinement module 812 can be embodied or implemented as one or more software applications or services executing on the computing device 800. The model generation and refinement module 812 can be executed by the processor 802 to generate and edit the model 502 to generate the refined model 504. For example, the model generation and refinement module 812 can implement a photogrammetry application or a 3D scanning application as described above with reference to FIG. 5 to generate the model 502. In this example, the model generation and refinement module 812 can then implement a parametric modeling application as described above with reference to FIG. 5 to edit the model 502 to generate the refined model 504. In some cases, the model generation and refinement module 812 can further implement the parametric modeling application as described above with reference to FIG. 5 to create the surface model 602 based on the refined model 504.

The mesostructure design module 814 can be embodied or implemented as one or more software applications or services executing on the computing device 800. The mesostructure design module 814 can be executed by the processor 802 to design the mesostructure 510. For example, the mesostructure design module 814 can implement a generative design application as described above with reference to FIG. 5 to design the mesostructure 510 such that it conforms to the outer periphery 508 of the refined model 504. In this example, the mesostructure design module 814 can implement the generative design application as described above with reference to FIG. 5 to design the mesostructure 510 such that it includes a thickness gradient extending from the inner periphery 512 to the outer periphery 514 of the mesostructure 510. In this way, the mesostructure design module 814 can design the mesostructure 510 such that it reduces peak linear acceleration during an impact. In some cases, the mesostructure design module 814 can implement the generative design application as described above with reference to FIG. 6 to design the mesostructure 510 such that it confirms to the outer periphery 604 of the surface model 602, instead of the outer periphery 508 of the refined model 504.

The mesostructure and helmet fabrication module 816 can be embodied or implemented as one or more software applications or services executing on the computing device 800. The mesostructure and helmet fabrication module 816 can be executed by the processor 802 to fabricate at least one of the mesostructure helmet 100, the mesostructure helmet 200, the mesostructure 104, the mesostructure 300a, the mesostructure 300b, or the mesostructure 510. For example, the mesostructure and helmet fabrication module 816 can be configured to operate the additive manufacturing device 822 to fabricate any or all of such mesostructures and mesostructure helmets. In one example, the mesostructure and helmet fabrication module 816 can be embodied and implemented as a 3D printing application executing on the computing device 800. In this example, the mesostructure and helmet fabrication module 816 can operate the additive manufacturing device 822 to fabricate any or all mesostructures and mesostructure helmets described herein using a 3D printing process.

The communications stack 818 can include software and hardware layers to implement data communications such as, for instance, Bluetooth®, Bluetooth® Low Energy (BLE), WiFi®, cellular data communications interfaces, or a combination thereof. Thus, the communications stack 818 can be relied upon by the computing device 800 to establish cellular, Bluetooth®, WiFi®, and other communications channels with one or more networks and one or more devices or systems external to the computing device 800.

The communications stack 818 can include the software and hardware to implement Bluetooth®, BLE, and related networking interfaces, which provide for a variety of different network configurations and flexible networking protocols for short-range, low-power wireless communications. The communications stack 818 can also include the software and hardware to implement WiFi® communication, and cellular communication, which also offers a variety of different network configurations and flexible networking protocols for mid-range, long-range, wireless, and cellular communications. The communications stack 818 can also incorporate the software and hardware to implement other communications interfaces, such as X10®, ZigBee®, Z-Wave®, and others. The communications stack 818 can be configured to communicate various data to and from a device or system that is external to the computing device 800. For example, the communications stack 818 can be configured to allow for the computing device 800 to share at least one of the above-described anthropometric aspects of an individual (e.g., the individual 102), the model 502, the refined model 504, the surface model 602, or other data.

The data collection devices 820 can each be configured and operable to capture and/or generate visual data indicative of the anthropometric aspects of an individual's head. In one example, each of the data collection devices 820 can capture one or more photos, images, or scans of the anthropometric aspects of an individual's head. In another example, each of the data collection devices 820 can capture visual data indicative of the anthropometric aspects of an individual's head and further generate a 3D scan such as, for instance, the model 502 based on the captured visual data. Examples of such data collection devices 820 can include, but are not limited to, a camera, a scanner, a 3D scanner, another data collection device, or any combination thereof.

The additive manufacturing device 822 can be configured and operable to fabricate any of the mesostructures and mesostructure helmets described herein. For instance, the additive manufacturing device 822 can be used to fabricate at least one of the mesostructure helmet 100, the mesostructure helmet 200, the mesostructure 104, the mesostructure 300a, the mesostructure 300b, or the mesostructure 510. In one example, the additive manufacturing device 822 can be embodied and implemented as a 3D printing device such as, for instance, a 3D printer. In this example, the additive manufacturing device 822 can be used to fabricate any mesostructure or mesostructure helmet described herein using a 3D printing process.

Referring now to FIG. 8, an executable program can be stored in any portion or component of the memory 804 including, for example, a random access memory (RAM), read-only memory (ROM), magnetic or other hard disk drive, solid-state, semiconductor, universal serial bus (USB) flash drive, memory card, optical disc (e.g., compact disc (CD) or digital versatile disc (DVD)), floppy disk, magnetic tape, or other types of memory devices.

In various embodiments, the memory 804 can include both volatile and nonvolatile memory and data storage components. Volatile components are those that do not retain data values upon loss of power. Nonvolatile components are those that retain data upon a loss of power. Thus, the memory 804 can include, for example, a RAM, ROM, magnetic or other hard disk drive, solid-state, semiconductor, or similar drive, USB flash drive, memory card accessed via a memory card reader, floppy disk accessed via an associated floppy disk drive, optical disc accessed via an optical disc drive, magnetic tape accessed via an appropriate tape drive, and/or other memory component, or any combination thereof. In addition, the RAM can include, for example, a static random-access memory (SRAM), dynamic random-access memory (DRAM), or magnetic random-access memory (MRAM), and/or other similar memory device. The ROM can include, for example, a programmable read-only memory (PROM), erasable programmable read-only memory (EPROM), electrically erasable programmable read-only memory (EEPROM), or other similar memory device.

As discussed above, the helmet design and fabrication service 810, the model generation and refinement module 812, the mesostructure design module 814, the mesostructure and helmet fabrication module 816, and the communications stack 818 can each be embodied, at least in part, by software or executable-code components for execution by general purpose hardware. Alternatively, the same can be embodied in dedicated hardware or a combination of software, general, specific, and/or dedicated purpose hardware. If embodied in such hardware, each can be implemented as a circuit or state machine, for example, that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components.

Referring now to FIG. 7, the flowchart or process diagram shown in FIG. 7 is representative of certain processes, functionality, and operations of the embodiments discussed herein. Each block can represent one or a combination of steps or executions in a process. Alternatively, or additionally, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as the processor 802. The machine code can be converted from the source code. Further, each block can represent, or be connected with, a circuit or a number of interconnected circuits to implement a certain logical function or process step.

Although the flowchart or process diagram shown in FIG. 7 illustrates a specific order, it is understood that the order can differ from that which is depicted. For example, an order of execution of two or more blocks can be scrambled relative to the order shown. Also, two or more blocks shown in succession can be executed concurrently or with partial concurrence. Further, in some embodiments, one or more of the blocks can be skipped or omitted. In addition, any number of counters, state variables, warning semaphores, or messages might be added to the logical flow described herein, for purposes of enhanced utility, accounting, performance measurement, or providing troubleshooting aids. Such variations, as understood for implementing the process consistent with the concepts described herein, are within the scope of the embodiments.

Also, any logic or application described herein, including the helmet design and fabrication service 810, the model generation and refinement module 812, the mesostructure design module 814, the mesostructure and helmet fabrication module 816, and the communications stack 818 can be embodied, at least in part, by software or executable-code components, can be embodied or stored in any tangible or non-transitory computer-readable medium or device for execution by an instruction execution system such as a general-purpose processor. In this sense, the logic can be embodied as, for example, software or executable-code components that can be fetched from the computer-readable medium and executed by the instruction execution system. Thus, the instruction execution system can be directed by execution of the instructions to perform certain processes such as those illustrated in FIG. 7. In the context of the present disclosure, a non-transitory computer-readable medium can be any tangible medium that can contain, store, or maintain any logic, application, software, or executable-code component described herein for use by or in connection with an instruction execution system.

The computer-readable medium can include any physical media such as, for example, magnetic, optical, or semiconductor media. More specific examples of suitable computer-readable media include, but are not limited to, magnetic tapes, magnetic floppy diskettes, magnetic hard drives, memory cards, solid-state drives, USB flash drives, or optical discs. Also, the computer-readable medium can include a RAM including, for example, an SRAM, DRAM, or MRAM. In addition, the computer-readable medium can include a ROM, a PROM, an EPROM, an EEPROM, or other similar memory device.

Disjunctive language, such as the phrase “at least one of X, Y, or Z,” unless specifically stated otherwise, is to be understood with the context as used in general to present that an item, term, or the like, can be either X, Y, or Z, or any combination thereof (e.g., X, Y, and/or Z). Thus, such disjunctive language is not generally intended to, and should not, imply that certain embodiments require at least one of X, at least one of Y, or at least one of Z to be each present.

As referenced herein, the term “user” refers to at least one of a human, an end-user, a consumer, a computing device and/or program (e.g., a processor, computing hardware and/or software, an application), an agent, an ML and/or AI model, and/or another type of user that can implement and/or facilitate implementation of one or more embodiments of the present disclosure as described herein, illustrated in the accompanying drawings, and/or included in the appended claims. As referred to herein, the terms “includes” and “including” are intended to be inclusive in a manner similar to the term “comprising.” As referenced herein, the terms “or” and “and/or” are generally intended to be inclusive, that is (i.e.), “A or B” or “A and/or B” are each intended to mean “A or B or both.” As referred to herein, the terms “first,” “second,” “third,” and so on, can be used interchangeably to distinguish one component or entity from another and are not intended to signify location, functionality, or importance of the individual components or entities. As referenced herein, the terms “couple,” “couples,” “coupled,” and/or “coupling” refer to chemical coupling (e.g., chemical bonding), communicative coupling, electrical and/or electromagnetic coupling (e.g., capacitive coupling, inductive coupling, direct and/or connected coupling), mechanical coupling, operative coupling, optical coupling, and/or physical coupling.

It should be emphasized that the above-described embodiments of the present disclosure are merely possible examples of implementations set forth for a clear understanding of the principles of the disclosure. Many variations and modifications can be made to the above-described embodiment(s) without departing substantially from the spirit and principles of the disclosure. All such modifications and variations are intended to be included herein within the scope of this disclosure and protected by the following claims.

Therefore, at least the following is claimed:

1. A process for designing a helmet for an individual, comprising:
generating a model of anthropometric aspects of a head of the individual using a scanning technique;
editing the model to generate a refined model of the anthropometric aspects of the head; and
designing a mesostructure based on the refined model.

2. The process for designing a helmet according to claim 1, wherein the scanning technique comprises a photogrammetry or a three-dimensional scanning technique.

3. The process for designing a helmet according to claim 1, wherein editing the model comprises removing at least one of an excess feature or an artifact from the model.

4. The process for designing a helmet according to claim 1, wherein editing the model comprises isolating a region of the model, the region corresponding to an area of the head that is to be protected.

5. The process for designing a helmet according to claim 1, wherein editing the model comprises adjusting the model to account for one or more anatomical features of at least one of the head or the individual.

6. The process for designing a helmet according to claim 1, wherein editing the model comprises adjusting the model to account for growth of the individual.

7. The process for designing a helmet according to claim 1, wherein designing the mesostructure comprises designing an inner periphery of the mesostructure to conform to an outer periphery of the refined model.

8. The process for designing a helmet according to claim 1, wherein designing the mesostructure comprises:
designing a latticed structure of graded thickness, the latticed structure comprising at least one first substructure positioned at an inner periphery of the latticed structure and at least one second substructure positioned at an outer periphery of the latticed structure, the at least one first substructure having a first thickness and the at least one second substructure having a second thickness that is greater than the first thickness.

9. The process for designing a helmet according to claim 1, further comprising:
creating a surface model based on the refined model, the surface model being representative of an outer periphery of the refined model; and
designing an inner periphery of the mesostructure to conform to the outer periphery of the surface model.

10. The process for designing a helmet according to claim 1, further comprising forming the mesostructure as a latticed structure of graded thickness using an additive manufacturing technique.

11. The process for designing a helmet according to claim 1, wherein the mesostructure comprises a Weaire-Phelan structure, an Elongated Kelvin cell structure, a Body-Centered Cubic Cell structure, a Type 1 structure, or a Type 2 structure.

12. The process for designing a helmet according to claim 1, wherein the mesostructure comprises a Weaire-Phelan structure of graded thickness, an Elongated Kelvin cell structure of graded thickness, a Body-Centered Cubic Cell structure of graded thickness, a Type 1 structure of graded thickness, or a Type 2 structure of graded thickness.

13. A personalized-fit helmet for an individual, comprising:
a mesostructure that conforms to anthropometric aspects of a head of the individual,
wherein the mesostructure comprises a latticed structure of graded thickness.

14. The personalized-fit helmet according to claim 13, wherein the latticed structure comprises at least one first substructure positioned at an inner periphery of the latticed structure and at least one second substructure positioned at an outer periphery of the latticed structure, the at least one first substructure having a first thickness and the at least one second substructure having a second thickness that is greater than the first thickness.

15. The personalized-fit helmet according to claim 13, wherein the mesostructure comprises a Weaire-Phelan structure, an Elongated Kelvin cell structure, a Body-Centered Cubic Cell structure, a Type 1 structure, or a Type 2 structure.

16. The personalized-fit helmet according to claim 13, further comprising a helmet securing system coupled to the mesostructure, to provide a personalized fit for the individual.

17. A personalized-fit helmet for an individual, comprising:
an outer shell; and
a mesostructure coupled to an inner surface of the outer shell,
wherein the mesostructure conforms to anthropometric aspects of a head of the individual, and
wherein the mesostructure comprises a latticed structure of graded thickness.

18. The personalized-fit helmet according to claim 17, wherein the latticed structure comprises at least one first substructure positioned at an inner periphery of the latticed structure and at least one second substructure positioned at an outer periphery of the latticed structure, the at least one first substructure having a first thickness and the at least one second substructure having a second thickness that is greater than the first thickness.

19. The personalized-fit helmet according to claim 17, wherein the mesostructure comprises a Weaire-Phelan structure, an Elongated Kelvin cell structure, a Body-Centered Cubic Cell structure, a Type 1 structure, or a Type 2 structure.

20. The personalized-fit helmet according to claim 17, further comprising a helmet securing system coupled to at least one of the mesostructure or the outer shell, to provide a personalized fit for the individual.
